(19) United States
(12) Patent Application Publication
(10) Pub. No.: US 2013/0298553 A1
(43) Pub. Date: Nov. 14, 2013

(54) EXHAUST GAS RECIRCULATION APPARATUS FOR HEAVY CONSTRUCTION EQUIPMENT

(71) Applicants: Ji Hoon Lim, Seoul (KR); Tae Joong Wang, Gyeonggi-do (KR)

(72) Inventors: Ji Hoon Lim, Seoul (KR); Tae Joong Wang, Gyeonggi-do (KR)

(73) Assignee: DOOSAN INFRACORE CO., LTD., Incheon (KR)

(21) Appl. No.: 13/981,212

(22) PCT Filed: Nov. 10, 2011
(86) PCT No.: PCT/KR2011/008555

§ 371 Date: Jul. 23, 2013

(30) Foreign Application Priority Data
Jan. 24, 2011 (KR) 1020110006705

(51) Int. Cl. F02M 25/07

(52) U.S. Cl. CPC F02M 25/07
USPC 60/605.2

(57) ABSTRACT

An exhaust gas recirculation apparatus for heavy construction equipment of the present disclosure, includes: a hybrid EGR line which introduces a part of exhaust gas from an exhaust manifold into a compressor so as not to pass through a turbine; and a hybrid EGR valve which is provided in the hybrid EGR line, and controlled to be opened and closed so that a part of the exhaust gas discharged from the exhaust manifold is introduced into an inlet of the compressor.

### CROSS-REFERENCE TO RELATED APPLICATION

This Application is a Section 371 National Stage Application of International Application No. PCT/KR2011/008555, filed Nov. 10, 2011 and published, not in English, as WO2012/102466 on Aug. 2, 2012.

### FIELD OF THE DISCLOSURE

The present disclosure relates to an exhaust gas recirculation (EGR) apparatus for heavy construction equipment, and more particularly, to an exhaust gas recirculation apparatus for heavy construction equipment, capable of controlling EGR gas at an appropriate pressure in an appropriate step when making exhaust gas discharged from an engine flow into the engine together with fresh gas.

### BACKGROUND OF THE DISCLOSURE

In general, an ultimate objective of an exhaust gas recirculation (EGR) apparatus mounted on an engine for heavy construction equipment is to control discharge of nitrogen compounds (NOx) by inducing complete combustion inside the engine rather than to achieve high output by using a turbocharger or the like.

In general, as the exhaust gas recirculation apparatus for heavy construction equipment, an apparatus is used which includes a high pressure EGR line which is provided with a high pressure EGR cooler and a high pressure EGR valve and does not pass through a turbocharger, and a low pressure EGR line which is provided with a low pressure EGR valve and a low pressure EGR cooler and passes through the turbocharger.

If the exhaust gas recirculation apparatus for heavy construction equipment is configured only with the high pressure EGR line which does not pass through the turbocharger, a process is necessary which allows a control balance between the exhaust gas recirculation apparatus and the turbocharger (T/C) to be maintained.

Further, if the low pressure EGR line is added in addition to the high pressure EGR line, because even the exhaust gas, which is moved to the turbocharger (T/C) and the existing high pressure EGR line, becomes an important factor that needs to be considered to be controlled, a control system, which maintains a balance between components, is necessary.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

An embodiment of the present disclosure has been made in consideration of the above problems in the related art, and the object of the present disclosure is to provide an exhaust gas recirculation apparatus for heavy construction equipment, capable of efficiently controlling a large amount of EGR gas by including a high pressure EGR line which does not pass through a turbocharger, a low pressure EGR line which passes through the turbocharger, and a hybrid EGR line which passes only through a compressor of the turbocharger.

To achieve the above object, an exhaust gas recirculation apparatus for heavy construction equipment according to the present disclosure includes: an engine including an intake manifold and an exhaust manifold; a turbocharger which rotates a turbine by using exhaust gas discharged from the engine, and compresses air supplied to the engine by using a compressor connected to the turbine through a connecting shaft; an intercooler which cools compressed air flowing into the engine; a high pressure EGR line which is provided with a high pressure EGR cooler, does not pass through the turbocharger, and introduces a part of the exhaust gas into the intercooler; a high pressure EGR valve which is provided in the high pressure EGR line, and controlled to be opened and closed so that a part of the exhaust gas is cooled in the high pressure EGR cooler, and then supplied to the intake manifold together with fresh gas compressed by the compressor; a low pressure EGR line which is provided with a low pressure EGR cooler, and introduces a part of the exhaust gas passing through the turbocharger into the compressor; a low pressure EGR valve which is provided in the low pressure EGR line, and controlled to be opened and closed so that a part of the exhaust gas passing through the turbine is introduced into the compressor via the low pressure EGR cooler; a hybrid EGR line which introduces a part of the exhaust gas from the exhaust manifold into the compressor so as not to pass through the turbine of the turbocharger; and a hybrid EGR valve which is provided in the hybrid EGR line, and controlled to be opened and closed so that a part of the exhaust gas discharged from the exhaust manifold is introduced into an inlet of the compressor.

In addition, in the exhaust gas recirculation apparatus for heavy construction equipment according to the present disclosure, the hybrid EGR line may be provided between an inlet side of the turbine and an inlet side of the low pressure EGR cooler.

In addition, in the exhaust gas recirculation apparatus for heavy construction equipment according to the present disclosure, the hybrid EGR line may be provided between an outlet side of the high pressure EGR cooler and an inlet side of the compressor.

In addition, in the exhaust gas recirculation apparatus for heavy construction equipment according to the present disclosure, the hybrid EGR line may be provided between an outlet side of the high pressure EGR cooler and an inlet side of the low pressure EGR cooler.

According to the exhaust gas recirculation apparatus for heavy construction equipment of the present disclosure, the EGR may be precisely controlled through the high pressure EGR line, the hybrid EGR line, and the low pressure EGR line, and as a result, an effect may be obtained in that NOx in the exhaust gas may be remarkably reduced, thereby contributing to environmental preservation, and marketability of the heavy construction equipment may be greatly improved.

### DESCRIPTION OF THE DRAWINGS

FIG. 1 is a configuration view of a first exemplary embodiment of the present disclosure.

FIG. 2 is a configuration view of a second exemplary embodiment of the present disclosure.

FIG. 3 is a configuration view of a third exemplary embodiment of the present disclosure.

FIG. 4 is a control flow chart of the present disclosure.

### DESCRIPTION OF MAIN REFERENCE NUMERALS OF DRAWINGS

110: Engine

111: Intake manifold

112: Exhaust manifold

120: Turbocharger

121: Turbine

122: Connecting shaft

123: Compressor

130: Intercooler

140: High pressure EGR line

150: Hybrid EGR line

160: Low pressure EGR line

### DETAILED DESCRIPTION

Hereinafter, specific technology contents of the present disclosure to achieve the aforementioned object will be described in detail with respect to the accompanying drawings.

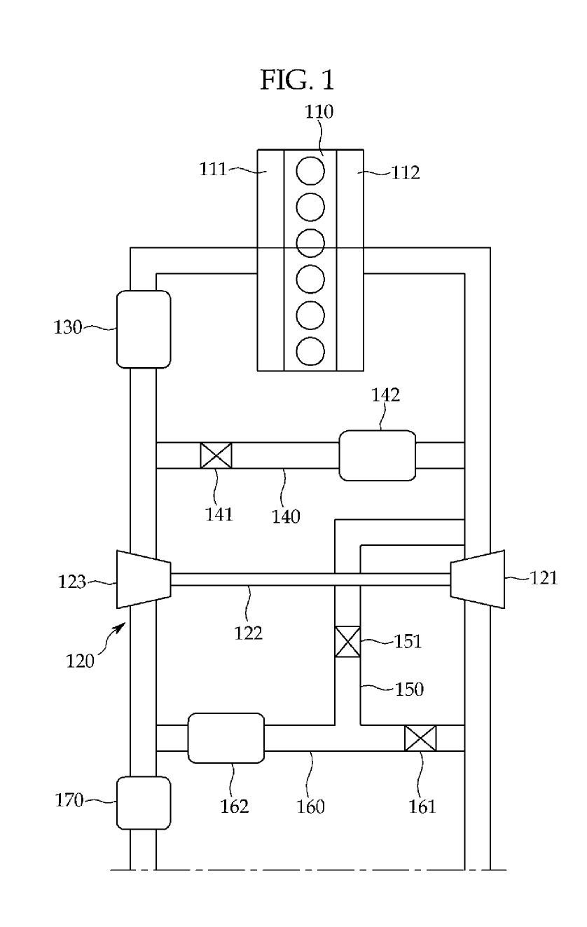

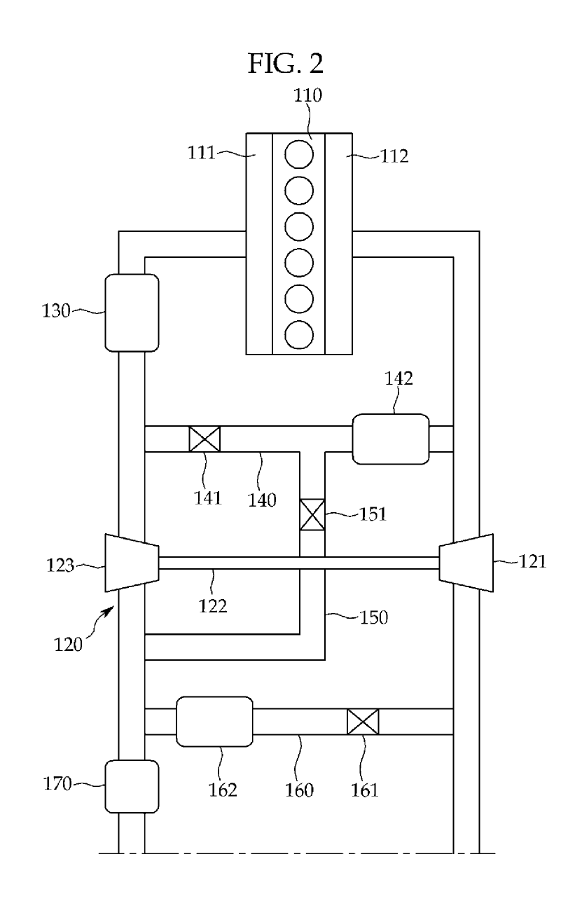

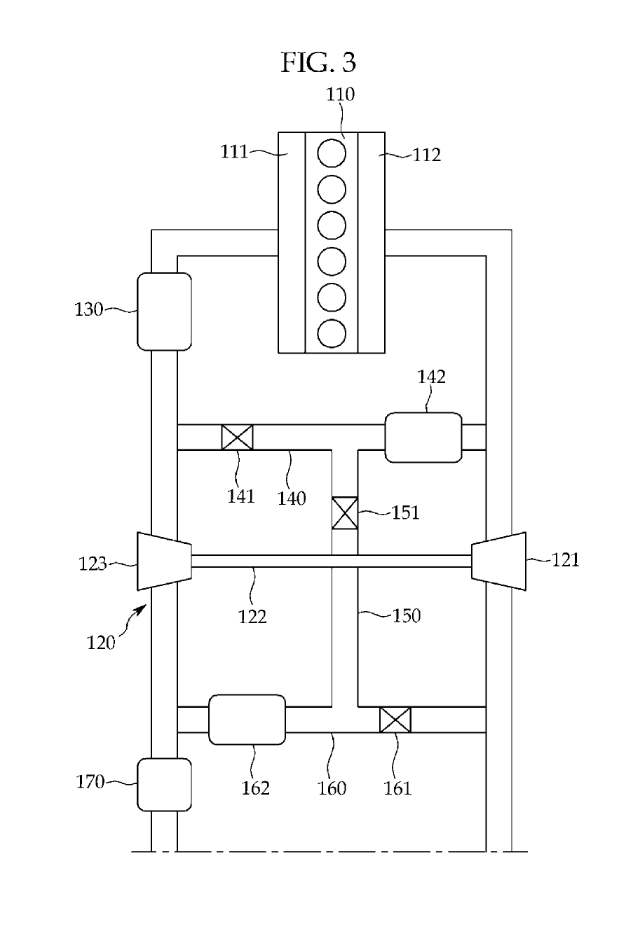

FIG. 1 illustrates a configuration view of a first exemplary embodiment of the present disclosure, FIG. 2 illustrates a configuration view of a second exemplary embodiment of the present disclosure, and FIG. 3 illustrates a configuration view of a third exemplary embodiment of the present disclosure.

As illustrated in FIGS. 1 to 3, an exhaust gas recirculation apparatus for heavy construction equipment of the present disclosure includes:

an engine 110;

a turbocharger 120 which rotates a turbine 121 by using exhaust gas discharged from the engine 110, and compresses air, which is supplied to the engine 110, by a compressor 123 connected to the turbine 121 through a connecting shaft 122;

an intercooler 130 which cools compressed air which flows into the engine 110;

a high pressure EGR line 140 which is provided with a high pressure EGR cooler 142 and a high pressure EGR valve 141, and does not pass through the turbocharger 120;

a low pressure EGR line 160 which is provided with a low pressure EGR valve 161 and a low pressure EGR cooler 162, and passes through the turbocharger 120; and

a hybrid EGR line 150 which is provided with a hybrid EGR valve 151, and does not passes through the turbine 121 of the turbocharger 120 but passes only through the compressor 123.

The first exemplary embodiment of the present disclosure, which is illustrated in FIG. 1, has a type in which the hybrid EGR line 150 is provided between an inlet side of the turbine 121 of the turbocharger 120 and an inlet side of the low pressure EGR cooler 162 of the low pressure EGR line 160.

In the first exemplary embodiment, when the high pressure EGR valve 141 is opened, a part of the exhaust gas discharged from an exhaust manifold 112 of the engine 110 is cooled in the high pressure EGR cooler 142, and then is supplied to an intake manifold 111 of the engine 110 together with fresh gas compressed by the compressor 123 while passing through the high pressure EGR valve 141 and the intercooler 130, and when the low pressure EGR valve 161 is opened, a part of the exhaust gas, which is discharged from the exhaust manifold 112 of the engine 110 and passes through the turbine 121 of the turbocharger 120, is introduced into the compressor 123 of the turbocharger 120 via the low pressure EGR valve 161 and the low pressure EGR cooler 162, compressed in the compressor 123 together with fresh gas flowing in through an air cleaner 170, and then supplied to the intake manifold 111 of the engine 110 via the intercooler 130.

Further, when the hybrid EGR valve 151 is opened, a part of the exhaust gas discharged from the exhaust manifold 112 of the engine 110 is introduced into the compressor 123 of the turbocharger 120 via the hybrid EGR valve 151 and the low pressure EGR cooler 162, compressed in the compressor 123 together with fresh gas flowing in through the air cleaner 170, and then supplied to the intake manifold 111 of the engine 110 via the intercooler 130.

The second exemplary embodiment of the present disclosure, which is illustrated in FIG. 2, has a type in which the hybrid EGR line 150 is provided between an outlet side of the high pressure EGR cooler 141 of the high pressure EGR line 140 and an inlet side of the compressor 123 of the turbocharger 120.

In the second exemplary embodiment, when the high pressure EGR valve 141 is opened, a part of the exhaust gas discharged from the exhaust manifold 112 of the engine 110 is cooled in the high pressure EGR cooler 142, and then is supplied to the intake manifold 111 of the engine 110 together with fresh gas compressed by the compressor 123 while passing through the high pressure EGR valve 141 and the intercooler 130, and when the low pressure EGR valve 160 is opened, a part of the exhaust gas, which is discharged from the exhaust manifold 112 of the engine 110 and passes through the turbine 121 of the turbocharger 120, is introduced into the compressor 123 of the turbocharger 120 via the low pressure EGR valve 141 and the low pressure EGR cooler 142, compressed in the compressor 123 together with fresh gas flowing in through the air cleaner 170, and then supplied to the intake manifold 111 of the engine 110 via the intercooler 130.

Further, when the hybrid EGR valve 151 is opened, a part of the exhaust gas discharged from the exhaust manifold 112 of the engine 110 is introduced into the compressor 123 of the turbocharger 120 via the high pressure EGR cooler 142 and the hybrid EGR valve 151, compressed in the compressor 123 together with fresh gas flowing in through the air cleaner 170, and then supplied to the intake manifold 111 of the engine 110 via the intercooler 130.

The third exemplary embodiment of the present disclosure, which is illustrated in FIG. 3, has a type in which the hybrid EGR line 150 is provided between an outlet side of the high pressure EGR cooler 141 of the high pressure EGR line 140 and an outlet side of the low pressure EGR valve 161 of the low pressure EGR line 160.

In the third exemplary embodiment, when the high pressure EGR valve 141 is opened, a part of the exhaust gas discharged from the exhaust manifold 112 of the engine 110 is cooled in the high pressure EGR cooler 142, and then is supplied to the intake manifold 111 of the engine 110 together with fresh gas compressed by the compressor 123 while passing through the high pressure EGR valve 141 and intercooler 130, and when the low pressure EGR valve 160 is opened, a part of the exhaust gas, which is discharged from the exhaust manifold 112 of the engine 110 and passes through the turbine 121 of the turbocharger 120, is introduced into the compressor 123 of the turbocharger 120 via the low pressure EGR valve 141 and the low pressure EGR cooler 142, compressed in the compressor 123 together with fresh gas flowing in through the air cleaner 170, and then supplied to the intake manifold 111 of the engine 110 via the intercooler 130.

Further, when the hybrid EGR valve 151 is opened, a part of the exhaust gas discharged from the exhaust manifold 112 of the engine 110 is introduced into the compressor 123 of the turbocharger 120 via the high pressure EGR cooler 142, the hybrid EGR valve 151, and the low pressure EGR cooler 142, compressed in the compressor 123 together fresh gas flowing in through the air cleaner 170, and then supplied to the intake manifold 111 of the engine 110 via the intercooler 130.

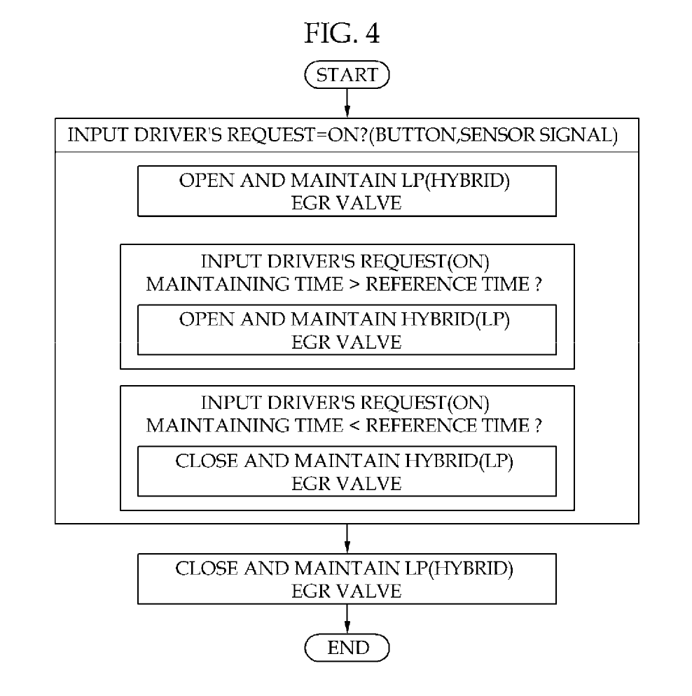

FIG. 4 illustrates a control flow chart of the present disclosure.

In the exhaust gas recirculation apparatus for heavy construction equipment of the present disclosure, as illustrated in FIG. 4, each of the EGR valves 141, 142, and 143 of each of the EGR lines 140, 150, and 160, respectively, may be optimally controlled by cooperation of a mechanical control and an electronic control.

For example, in the exhaust gas recirculation apparatus for heavy construction equipment of the present disclosure, an engine control unit (ECU) basically and ordinarily performs a high pressure EGR valve control, and may use a combination of a mechanical control in which the engine control unit (ECU), which receives a low load request signal, a traveling signal, or an idle signal from a driver, operates the hybrid EGR valve 151 of the hybrid EGR line 150 or the low pressure EGR valve 161 of the low pressure EGR line 160, and an electronic control in which the engine control unit (ECU), which receives a high load request signal and a signal informing an entry into a work mode from the driver, opens and closes each of the EGR valves 141, 151, and 161 of each of the EGR lines 140, 150, and 160, respectively, in accordance with a variation amount of an engine rpm, a vehicle velocity (vehicle_v), and torque.

In the exhaust gas recirculation apparatus for heavy construction equipment of the present disclosure, operations of the low pressure EGR valve 161 and the hybrid EGR valve 151 may be performed in accordance with a driver's input signal, and the sequential order of controlling the respective EGR valves may be determined in consideration of properties of the respective valves.

For example, in the exhaust gas recirculation apparatus for heavy construction equipment of the present disclosure, the high pressure EGR valve 141 is used depending on various basic signals in general middle, low, and high load modes.

The hybrid EGR valve 151 is used in a high load work stand-by mode and a low load work mode, and has a merit of supplying a large amount of EGR gas in a short period of time, but is relatively vulnerable in terms of stability compared to the low pressure EGR valve 161.

The low pressure EGR valve 161 is used in a low load work stand-by mode and a mode below the low load work stand-by mode, has high stability, and may supply a large amount of EGR gas, but has a drawback in that responsiveness is low.

As such, the exhaust gas recirculation apparatus for heavy construction equipment of the present disclosure allows a supply of a large amount of EGR gas to be possible by adding hybrid/low pressure EGR loops in addition to an existing high pressure EGR loop, has a type in which the EGR gas passing through the high pressure EGR loop does not go through a compression process, but the EGR gas passing through the hybrid/low pressure EGR loops flows into the engine through the compression process, makes a combination of hybrid/low pressure possible by simplifying a type in which the existing hybrid EGR loop and the low pressure EGR loop are combined, and may adjust various EGR rates and a temperature of intake gas flowing into the engine in accordance with operations of the respective EGR valves, thereby variously supplying EGR gas according to each operation condition.

The present disclosure described above is not limited to the aforementioned description, and it is apparent to the person skilled in the art that various substitutions, modifications, and alterations may be possible without departing from the technical spirit of the present disclosure.

The exhaust gas recirculation (EGR) apparatus for heavy construction equipment according to the present disclosure may be used to control EGR gas at an appropriate pressure in an appropriate step when making exhaust gas discharged from an engine flow into the engine together with fresh gas.

Although the present disclosure has been described with reference to exemplary and preferred embodiments, workers skilled in the art will recognize that changes may be made in form and detail without departing from the spirit and scope of the disclosure.

1. An exhaust gas recirculation apparatus for heavy construction equipment, comprising:
an engine including an intake manifold and an exhaust manifold;
a turbocharger which is configured to rotate a turbine by using exhaust gas discharged from the engine, and compress air supplied to the engine by using a compressor connected to the turbine through a connecting shaft;
an intercooler which is configured to cool compressed air flowing into the engine;
a high pressure EGR line which is provided with a high pressure EGR cooler, does not pass through the turbocharger, and introduces a part of the exhaust gas into the intercooler;
a high pressure EGR valve which is provided in the high pressure EGR line, and controlled to be opened and closed so that a part of the exhaust gas is cooled in the high pressure EGR cooler, and then supplied to the intake manifold together with fresh gas compressed by the compressor;
a low pressure EGR line which is provided with a low pressure EGR cooler, and introduces a part of the exhaust gas passing through the turbocharger into the compressor;
a low pressure EGR valve which is provided in the low pressure EGR line, and controlled to be opened and closed so that a part of the exhaust gas passing through the turbine is introduced into the compressor via the low pressure EGR cooler;
a hybrid EGR line which introduces a part of the exhaust gas from the exhaust manifold into the compressor so as not to pass through the turbine of the turbocharger; and
a hybrid EGR valve which is provided in the hybrid EGR line, and controlled to be opened and closed so that a part of the exhaust gas discharged from the exhaust manifold 442 is introduced into an inlet of the compressor.

2. The exhaust gas recirculation apparatus of claim 1, wherein the hybrid EGR line is provided between an inlet side of the turbine and an inlet side of the low pressure EGR cooler.

3. The exhaust gas recirculation apparatus of claim 1, wherein the hybrid EGR line is provided between an outlet side of the high pressure EGR cooler and an inlet side of the compressor.

4. The exhaust gas recirculation apparatus of claim 1, wherein the hybrid EGR line is provided between an outlet side of the high pressure EGR cooler and an inlet side of the low pressure EGR cooler.
